(19) United States
(12) Patent Application Publication
(10) Pub. No.: US 2025/0309995 A1
(43) Pub. Date: Oct. 2, 2025

(54) OPTICAL RECEPTION DEVICE AND OPTICAL RECEPTION METHOD

(71) Applicant: Fujitsu Limited, Kawasaki-shi (JP)

(72) Inventors: Daisuke SASAKI, Yokohama (JP); yoshitaka NOMURA, shinagawa (JP)

(73) Assignee: Fujitsu Limited, Kawasaki-shi (JP)

(21) Appl. No.: 19/028,887

(22) Filed: Jan. 17, 2025

(30) Foreign Application Priority Data
Mar. 28, 2024 (JP) 2024-053935

(51) Int. Cl. H04B 10/61

(52) U.S. Cl. CPC H04B 10/6165

(57) ABSTRACT

An optical reception device includes: a reception circuit that performs digital coherent reception of an optical signal to which a probabilistic constellation shaping (PCS) is applied; a conversion circuit that samples an electric field signal in an analog format that represents an optical electric field component of the optical signal and converts the electric field signal into a digital signal in a digital format; a detection circuit that detects a sampling phase of the digital signal and generates sampling phase information that corresponds to the sampling phase; a compensation circuit that compensates for the sampling phase of the digital signal based on the sampling phase information; and an adjustment circuit that adjusts signal intensity of the digital signal before the sampling phase information is generated.

### CROSS-REFERENCE TO RELATED APPLICATION

This application is based upon and claims the benefit of priority of the prior Japanese Patent Application No. 2024-53935, filed on Mar. 28, 2024, the entire contents of which are incorporated herein by reference.

### FIELD

The embodiments discussed herein are related to an optical reception device and an optical reception method.

### BACKGROUND

An optical receiver having three functions of reshaping, retiming, and regenerating is known. Furthermore, a coherent optical transmitter including an optical source and an optical modulator, and a coherent optical receiver including an analog to digital converter (ADC) and a digital signal processor (DSP) are also known. In addition, an optical transmission system that performs optical transmission control is also known.

Japanese Laid-open Patent Publication No. 2003-198467, U.S. Patent Application Publication No. 2018/0269985, U.S. Patent Application Publication No. 2018/0183631, and Japanese Laid-open Patent Publication No. 2003-037562 are disclosed as related art.

### SUMMARY

According to an aspect of the embodiments, an optical reception device includes: a reception circuit that performs digital coherent reception of an optical signal to which a probabilistic constellation shaping (PCS) is applied; a conversion circuit that samples an electric field signal in an analog format that represents an optical electric field component of the optical signal and converts the electric field signal into a digital signal in a digital format; a detection circuit that detects a sampling phase of the digital signal and generates sampling phase information that corresponds to the sampling phase; a compensation circuit that compensates for the sampling phase of the digital signal based on the sampling phase information; and an adjustment circuit that adjusts signal intensity of the digital signal before the sampling phase information is generated.

The object and advantages of the invention will be realized and attained by means of the elements and combinations particularly pointed out in the claims.

It is to be understood that both the foregoing general description and the following detailed description are exemplary and explanatory and are not restrictive of the invention.

### BRIEF DESCRIPTION OF DRAWINGS

FIG. 1 is an example of an optical transmission system;

FIG. 2A is an example of a constellation of 16 quadrature amplitude modulation (QAM); FIG. 2B is an example of a constellation of probabilistic constellation shaping (PCS)-16QAM;

FIG. 3 is an example of an optical reception device;

FIG. 4 is an example of a sampling phase synchronization unit according to a first embodiment;

FIG. 5 is a diagram for describing an example of an effect;

FIG. 6 is a diagram for describing another example of the effect;

FIG. 7 is a flowchart illustrating an example of an operation of the optical reception device according to the first embodiment;

FIG. 8 is an example of a sampling phase synchronization unit according to a second embodiment;

FIG. 9 is an example of a control unit according to the second embodiment;

FIG. 10 is a diagram for describing an example of a first database (DB);

FIG. 11 is a flowchart illustrating an example of an operation of an optical reception device according to the second embodiment;

FIG. 12 is another example of the control unit according to the second embodiment;

FIG. 13 is a diagram for describing an example of a second DB; and

FIG. 14 is a flowchart illustrating another example of the operation of the optical reception device according to the second embodiment.

### DESCRIPTION OF EMBODIMENTS

In the coherent optical transmitter, an optical signal may be modulated using a multi-level modulation system referred to as 16 quadrature amplitude modulation (QAM). The 16QAM is one of the multi-level modulation systems capable of transmitting 4-bit (for example, 16-valued) information in one symbol (signal point). When the 16QAM is used, 16 types of symbols are arranged in a constellation according to a combination of a phase and an amplitude of an optical signal.

The outer symbol arranged farther from a center of the constellation has the larger amplitude of the optical signal, and more power is needed when the optical signal is transmitted. For example, the inner symbol arranged near the center of the constellation enables transmission of the optical signal with less power. In the case of the 16QAM, the 16 types of symbols are used with an equal probability when the optical signal is transmitted.

In the coherent optical transmitter, the multi-level modulation system referred to as PCS-16QAM in which a technology referred to as probabilistic constellation shaping (PCS) is applied to the 16QAM may be used. When the PCS-16QAM is used, the inner symbol arranged near the center of the constellation is stochastically used at a high frequency when the optical signal is transmitted. On the other hand, the outer symbol arranged farther from the center of the constellation is stochastically used at a low frequency when the optical signal is transmitted.

In this manner, when the PCS-16QAM is used, the inner symbol is used more preferentially than the outer symbol. As a result, power needed when the optical signal is transmitted is reduced as compared with that of the 16QAM. Furthermore, since the inner symbol having the small amplitude of the optical signal is preferentially used, discrimination between symbols is improved, and resistance to noise is improved. The coherent optical receiver may receive the optical signal modulated using such PCS-16QAM.

When the optical signal is received, the coherent optical receiver converts an electric field signal in an analog format representing an optical electric field component of the optical signal into a digital signal in a digital format, and detects a sampling phase of the digital signal. However, in a case where the PCS-16QAM is used in the coherent optical transmitter, the optical signal received by the coherent optical receiver has a low probability of including the outer symbol having the large amplitude. Therefore, signal intensity of the optical signal depending on the amplitude of the optical signal decreases. When the signal intensity of the optical signal decreases, signal intensity of the digital signal decreases, and detection sensitivity of the sampling phase of the digital signal decreases. In this case, there is a possibility that the coherent optical receiver may not accurately demodulate the digital signal.

Therefore, in one aspect, an object is to provide an optical reception device and an optical reception method that suppress a decrease in phase detection sensitivity of a sampling phase in a case where the PCS is applied to the multi-level modulation system.

Hereinafter, modes for carrying out the present case will be described with reference to the drawings.

### First Embodiment

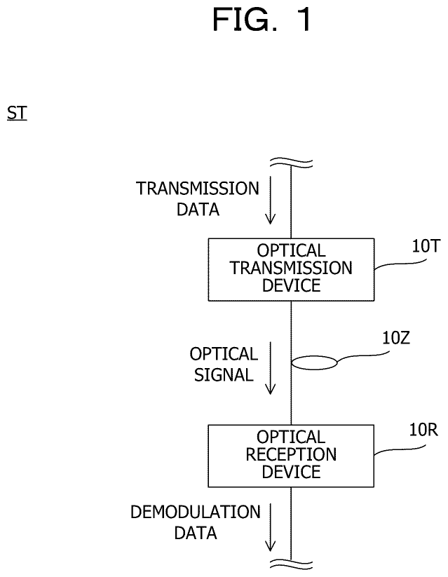

As illustrated in FIG. 1, an optical transmission system ST includes an optical transmission device 10T and an optical reception device 10R. The optical reception device 10R includes a digital coherent receiver. The optical transmission device 10T and the optical reception device 10R are coupled by a transmission line 10Z such as an optical fiber. A repeater such as an optical amplifier may be provided in the transmission line 10Z.

When transmission data is input, the optical transmission device 10T transmits an optical signal modulated based on the transmission data to the transmission line 10Z. For example, the optical transmission device 10T transmits the optical signal modulated by probabilistic constellation shaping (PCS)-16 quadrature amplitude modulation (QAM) based on the transmission data. The optical signal propagates through the transmission line 10Z. The optical reception device 10R receives the optical signal transmitted from the optical transmission device 10T from the transmission line 10Z, demodulates the optical signal, and outputs demodulation data corresponding to the optical signal.

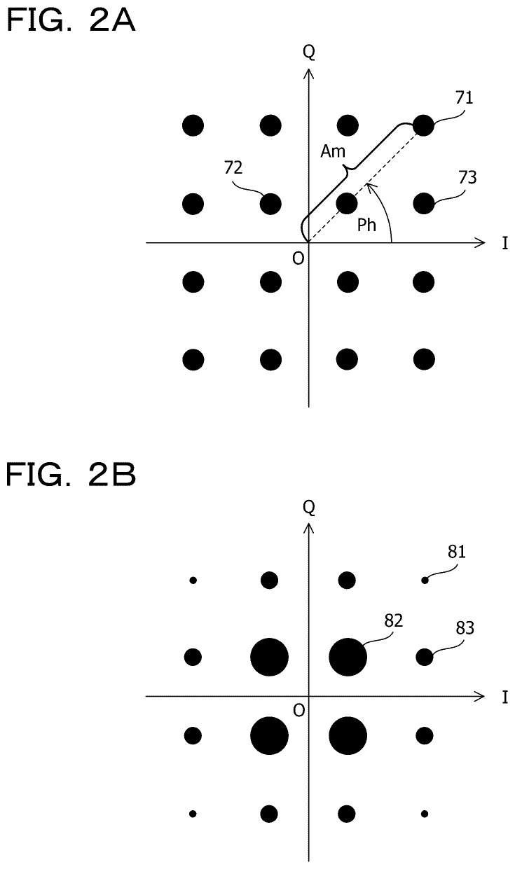

Next, a difference between 16QAM and the PCS-16QAM will be described with reference to FIGS. 2A and 2B.

First, as illustrated in FIG. 2A, when the 16QAM is used to modulate an optical signal, 16 types of symbols are arranged in a constellation according to a combination of a phase Ph and an amplitude Am of the optical signal. The constellation is a two-dimensional plane in which an I (in-phase) axis and a Q (orthogonal) axis are orthogonal to each other. Mutually different four bits are mapped to each symbol. A probability that each symbol is used when the optical signal is transmitted is the same. Note that, in FIG. 2A, each symbol is illustrated with the same size. Each symbol having the same size expresses that each symbol is used with the same probability.

An outer symbol arranged farther from a center O of the constellation has the larger amplitude of the optical signal, and more power is consumed when the optical signal is transmitted. For example, an outer symbol 71 arranged farthest from the center O of the constellation has the largest amplitude of the optical signal. Therefore, compared with an inner symbol 72 arranged closest to the center O of the constellation, more power is consumed for transmitting the optical signal in the symbol 71. Furthermore, also compared with a symbol 73 arranged second closest to the symbol 72 from the center O of the constellation, more power is consumed for transmitting the optical signal in the symbol 71. Therefore, the inner symbol arranged near the center O of the constellation enables transmission of the optical signal with less power.

Next, as illustrated in FIG. 2B, when the PCS-16QAM is used to modulate an optical signal, 16 types of symbols are arranged in a constellation similarly to the case of the 16QAM. In a case where the PCS-16QAM is used, probabilities that the respective symbols are used when the optical signal is transmitted are different. Therefore, in FIG. 2B, the 16 types of symbols are illustrated in three different sizes. The 16 types of symbols having the three different sizes express that these symbols are used with three different probabilities.

For example, an outer symbol 81 arranged farthest from a center O of the constellation is illustrated with the smallest size. For example, when the optical signal is transmitted, the symbol 81 is used with the lowest probability. On the other hand, an inner symbol 82 arranged closest to the center O of the constellation is illustrated with the largest size. For example, when the optical signal is transmitted, the symbol 82 is used with the highest probability. A symbol 83, which has the size between the size of the symbol 81 and the size of the symbol 82, is used with a probability between the probability that the symbol 81 is used and the probability that the symbol 82 is used.

Furthermore, as described above, the symbol 81 has the smallest size. Therefore, even if the size of the symbol 81 slightly increases based on an increase in variation due to noise, a Euclidean distance between the symbol 81 and the symbol 82 adjacent to the symbol 81 is sufficiently secured. Therefore, in a case where the PCS-16QAM is used, erroneous determination between the symbol 81 and the symbol 82 is suppressed, and discrimination between the symbol 81 and the symbol 82 is improved. Similarly, even if the size of the symbol 81 slightly increases due to the increase in the variation due to the noise, a Euclidean distance between the symbol 81 and the symbol 83 adjacent to the symbol 81 is also sufficiently secured. Therefore, in a case where the PCS-16QAM is used, erroneous determination between the symbol 81 and the symbol 83 is suppressed, and discrimination between the symbol 81 and the symbol 83 is also improved. In this manner, in a case where the PCS-16QAM is used, noise resistance of the symbol 81 is improved.

However, in a case where the PCS-16QAM is used, average intensity (hereinafter, referred to as signal power) of the signals represented by a sum of a square of an I component and a square of a Q component of the symbol decreases as compared with a case where the 16QAM is used. For example, in both the PCS-16QAM and the 16QAM, as the symbol is arranged closer to the center O of the constellation, the amplitude decreases, and the signal power depending on the amplitude of the optical signal decreases. However, in the case of the PCS-16QAM, the probability that the inner symbol is used is higher than that of the 16QAM. Furthermore, in the case of the PCS-16QAM, the probability that the outer symbol is used is lower than that of the 16QAM. Therefore, when the probability that the symbol is used is considered, the signal power in a case where the PCS-16QAM is used is lower than the signal power in a case where the 16QAM is used.

Although details will be described later, in a case where the signal power decreases in this manner, when the optical reception device 10R detects a sampling phase by a predetermined phase detection method such as a Gardner system, there is a possibility that detection sensitivity decreases. This is because the predetermined phase detection method such as the Gardner system needs, for example, signal power equal to or higher than the signal power in a case where the 16QAM is used. In this manner, when the detection sensitivity decreases, it becomes difficult for the optical reception device 10R to accurately generate sampling phase information corresponding to the sampling phase. For example, it is difficult for the optical reception device 10R to accurately generate the sampling phase information including a sampling phase error.

Since the optical reception device 10R compensates for a sampling phase error of a digital signal corresponding to the optical signal based on the sampling phase information, compensation accuracy of the sampling phase decreases in a case where accuracy of the sampling phase information is low. As a result, there is a possibility that the optical reception device 10R may not accurately demodulate the digital signal. Therefore, in the first embodiment, the optical reception device 10R that increases the signal power before generating the sampling phase information will be described.

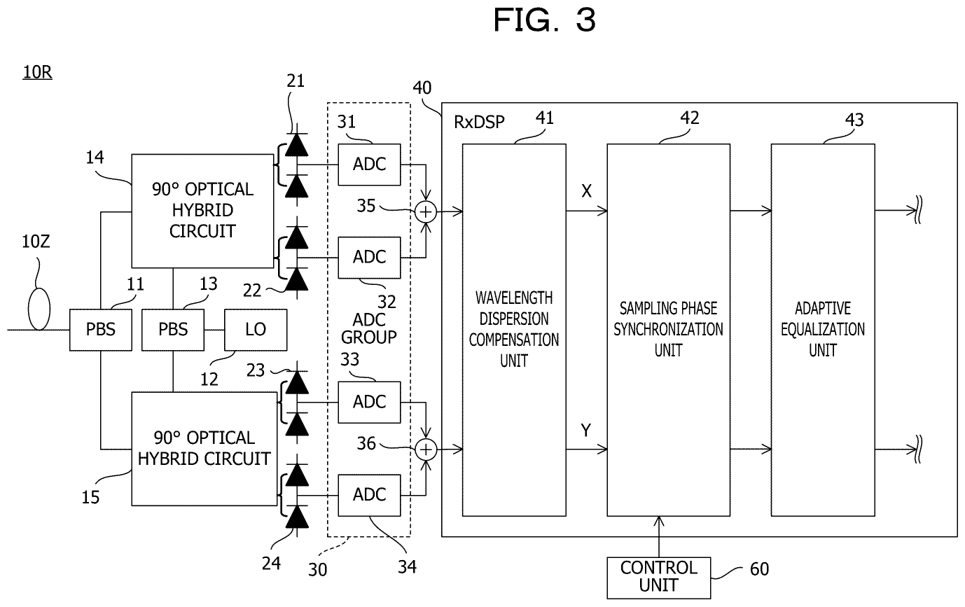

Details of the optical reception device 10R will be described with reference to FIG. 3.

When the optical reception device 10R receives an optical signal from the transmission line 10Z, the optical signal is input to a polarization beam splitter (PBS) 11. The PBS 11 separates the optical signal into X-polarization components and Y-polarization components. The X-polarization components are input to a 90° optical hybrid circuit 14. The Y-polarization components are input to a 90° optical hybrid circuit 15. Local oscillation light output from a local oscillator (LO) 12 is separated by a PBS 13. The local oscillation light is input to each of the 90° optical hybrid circuits 14 and 15.

The 90° optical hybrid circuit 14 detects the X-polarization components by the local oscillation light, outputs an interference component in phase (I component) to a balanced photo diode (BPD) 21 as a photoelectric converter, and outputs an interference component at a 90° phase difference (Q component) to a BPD 22. The 90° optical hybrid circuit 15 detects the Y-polarization components by the local oscillation light, outputs an interference component in phase (I component) to a BPD 23, and outputs an interference component at the 90° phase difference (Q component) to a BPD 24. In this manner, the 90° optical hybrid circuits 14 and 15 separate the optical signal into the total of four channel optical signals of the X-polarization I component, the X-polarization Q component, the Y-polarization I component, and the Y-polarization Q component, and output the optical signals to the corresponding BPDs 21, 22, 23, and 24. Note that an optical front end module as a reception unit is implemented by the PBSs 11 and 13, the 90° optical hybrid circuits 14 and 15, and the BPDs 21, 22, 23, and 24.

Each of the BPDs 21, 22, 23, and 24 converts each input optical signal into an electric field signal in an analog format representing an optical electric field component of the optical signal. Each electric field signal is input to corresponding one of analog to digital converters (ADCs) 31, 32, 33, and 34 in an ADC group 30. The ADCs 31, 32, 33, and 34 are examples of a conversion unit. Each of the ADCs 31, 32, 33, and 34 performs digital sampling at a sampling timing synchronized with a sampling frequency output from a frequency variable oscillator (not illustrated). For example, each of the ADCs 31, 32, 33, and 34 performs sampling twice per symbol (double oversampling).

As a result, an analog value of each electric field signal is converted into a digital value, and developed in parallel up to a clock speed that may be implemented by a large-scale integration (LSI) such as a complementary metal-oxide-semiconductor (CMOS). Each of digital signals of the X-polarization I component and the X-polarization Q component is added by an adder circuit 35 and input to a reception side digital signal processor (DSP) (referred to as RxDSP in FIG. 3) 40 as an X-channel digital signal. Each of digital signals of the Y-polarization I component and the Y-polarization Q component is added by an adder circuit 36 and input to the reception side DSP 40 as a Y-channel digital signal.

The reception side DSP 40 includes a wavelength dispersion compensation unit 41, a sampling phase synchronization unit 42, an adaptive equalization unit 43, and the like. Although not illustrated in FIG. 3, the reception side DSP 40 includes, for example, an error correction decoding unit that demodulates a digital signal and outputs demodulation data, and the like in a subsequent stage of the adaptive equalization unit 43. The wavelength dispersion compensation unit 41, the sampling phase synchronization unit 42, the adaptive equalization unit 43, and the like may be implemented by a single DSP or may be implemented by individual DSPs.

The sampling phase synchronization unit 42 is controlled by a control unit 60 that controls the optical reception device 10R as a whole. The control unit 60 is provided in the optical reception device 10R. The control unit 60 may be implemented by a hardware circuit. The hardware circuit may be processor such as a central processing unit (CPU), or may be a field programmable gate array (FPGA) or an application specific integrated circuit (ASIC).

The wavelength dispersion compensation unit 41 estimates waveform distortion of the X-polarization components of the optical signal due to wavelength dispersion based on the X-channel digital signals output from the adder circuit 35, and compensates for the waveform distortion due to the wavelength dispersion. Similarly, the wavelength dispersion compensation unit 41 estimates waveform distortion of the Y-polarization components of the optical signal due to wavelength dispersion based on the Y-channel digital signals output from the adder circuit 36, and compensates for the waveform distortion due to the wavelength dispersion.

The sampling phase synchronization unit 42 performs sampling phase compensation for each of the X-channel and Y-channel digital signals in which the waveform distortion due to the wavelength dispersion has been compensated, and outputs the digital signal to the adaptive equalization unit 43 in a subsequent stage. The adaptive equalization unit 43 performs compensation for characteristics of the transmission line 10Z based on a tap coefficient for each of the X-channel and Y-channel digital signals for which the sampling phase compensation has been performed.

For example, the adaptive equalization unit 43 compensates for waveform distortion or the like caused by polarization mode dispersion (PMD), polarization dependent loss (PDL), or the like. When the compensation for the characteristics of the transmission line 10Z is performed, the adaptive equalization unit 43 outputs each of the X-channel and Y-channel digital signals for which the compensation has been performed to the error correction decoding unit or the like provided at the subsequent stage of the adaptive equalization unit 43. The error correction decoding unit demodulates each of the X-channel and Y-channel digital signals, and outputs demodulation data. As a result, the demodulation data is output from the optical reception device 10R.

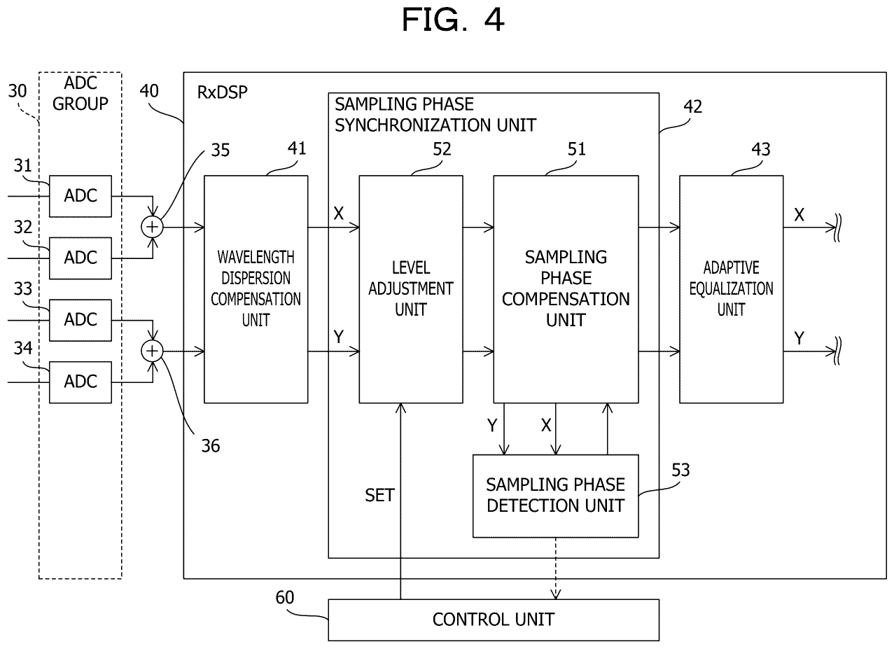

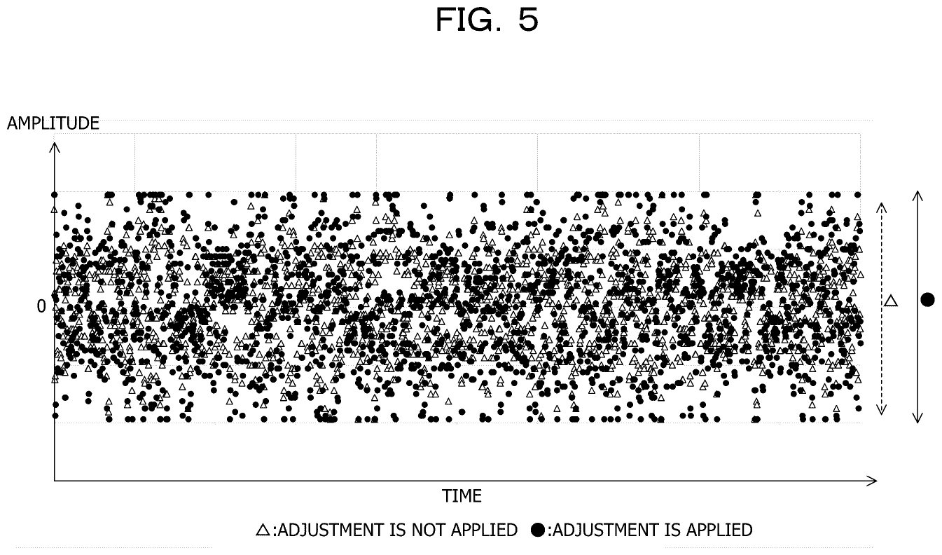

Details of the sampling phase synchronization unit 42 will be described with reference to FIGS. 4 and 5.

The sampling phase synchronization unit 42 includes a sampling phase compensation unit 51 as a compensation unit, a level adjustment unit 52 as an adjustment unit, and a sampling phase detection unit 53 as a detection unit. Each of the X-channel and Y-channel digital signals in which the waveform distortion due to the wavelength dispersion has been compensated by the wavelength dispersion compensation unit 41 is input to the level adjustment unit 52.

The level adjustment unit 52 adjusts a signal level of each of the X-channel and Y-channel digital signals based on setting of a level adjustment value by the control unit 60 before sampling phase information is generated. The level adjustment value is, for example, a fixed magnification such as 1 time or 1.5 times. When the signal level is adjusted, signal power changes.

For example, when 1.5 times is selected as the level adjustment value, the signal power increases. When 1 time is selected as the level adjustment value, the increased signal power is invalidated and returns to the original signal power before the increase. In this manner, the level adjustment unit 52 adjusts signal power of each of the X-channel and Y-channel digital signals, and outputs the adjusted signal power to the sampling phase compensation unit 51.

The sampling phase compensation unit 51 causes each of the X-channel and Y-channel digital signals output from the level adjustment unit 52 to be branched, and outputs the branched digital signals to the sampling phase detection unit 53. The sampling phase detection unit 53 detects a sampling phase of each of the X-channel and Y-channel digital signals, and generates sampling phase information corresponding to the sampling phase. The sampling phase represents a timing at which sampling is actually executed within one symbol section based on an ideal sampling timing. The ideal sampling timing is a timing at which each symbol reaches the optical reception device 10R.

For example, the sampling phase detection unit 53 detects a sampling phase error of each of the X-channel and Y-channel digital signals by the predetermined phase detection method including filtering processing such as the Gardner system. The sampling phase error represents a magnitude and a direction of a timing error between the ideal sampling timing and the actual sampling timing with respect to a phase of a symbol of the digital signal in the ADC group 30. The direction of the timing error is advance or delay of the sampling timing, and may be expressed by, for example, positive and negative signs. In order to always maintain the ideal sampling timing, the optical reception device 10R detects the sampling phase error and compensates for the sampling phase error. As a result, signal quality of the digital signal is improved.

When the sampling phase error is detected, the sampling phase detection unit 53 generates sampling phase information including a compensation amount corresponding to the sampling phase error, and notifies the sampling phase compensation unit 51 of the sampling phase information. For example, the sampling phase detection unit 53 removes noise from the sampling phase error by a loop filter, and generates and notifies sampling phase information including the sampling phase error from which the noise has been removed as the compensation amount.

The sampling phase compensation unit 51 compensates for the sampling phase of each of the X-channel and Y-channel digital signals based on the compensation amount included in the sampling phase information, and outputs the sampling phase to the adaptive equalization unit 43. Note that, for example, Japanese Laid-open Patent Publication No. 2011-009956 and Japanese Laid-open Patent Publication No. 2012-253461 may be referred to as the sampling phase detection unit 53.

The control unit 60 uniquely sets the level adjustment value corresponding to an operation mode (hereinafter, simply referred to as a mode) of the optical transmission system ST in the level adjustment unit 52. The control unit 60 holds a plurality of the modes and the level adjustment values corresponding to the respective plurality of modes. When any one of the plurality of modes is selected, the control unit 60 specifies the level adjustment value corresponding to the mode, and sets the specified level adjustment value in the level adjustment unit 52.

At the time of initial activation before an operation of the optical reception device 10R is started, any one of the plurality of modes is instructed to the control unit 60. The instruction to the control unit 60 may be performed from, for example, an external terminal device coupled to the optical reception device 10R. The external terminal device includes, for example, a personal computer (PC), a dedicated terminal, or the like.

Here, when 1.5 times is set as the level adjustment value, the signal power of each of the X-channel and Y-channel digital signals input to the sampling phase detection unit 53 is increased. In this manner, by applying adjustment to increase the signal power, as illustrated in FIG. 5, an amplitude of the digital signal is amplified as compared with a case where the adjustment is not applied, and variation increases. As a result, the sampling phase detection unit 53 may suppress a decrease in phase detection sensitivity of the sampling phase.

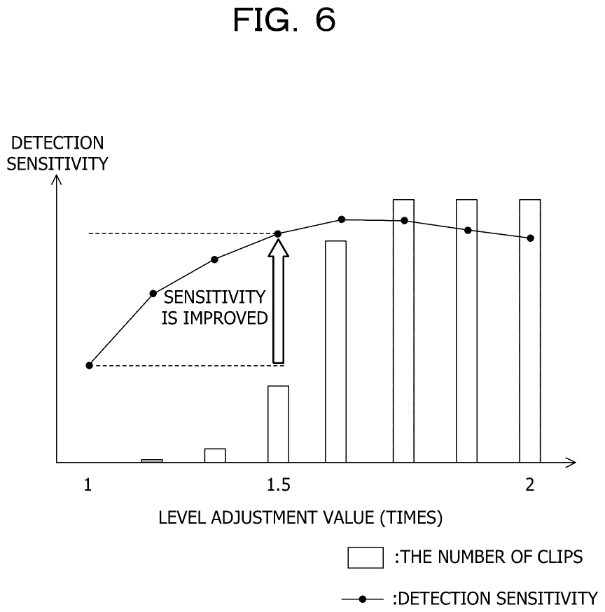

An effect of the present case will be described with reference to FIG. 6.

First, when 1.5 times or a magnification close thereto is selected as the level adjustment value, the detection sensitivity of the sampling phase by the sampling phase detection unit 53 is improved. For example, when 1.5 times or the magnification close thereto is selected as the level adjustment value, the detection sensitivity is improved about several times as compared with a case where 1 time is selected as the level adjustment value. On the other hand, when a magnification exceeding a magnification close to 1.5 times is selected as the level adjustment value, the detection sensitivity gradually decreases as the magnification increases. Therefore, in a case where the detection sensitivity is considered alone, it is desirable to select 1.5 times or the magnification close thereto as the level adjustment value.

On the other hand, in a case where the magnification exceeding 1.5 times is selected as the level adjustment value, the number of clips increases. The number of clips is the total number of symbols in which a clip has occurred. The clip is, for example, a phenomenon in which the signal power of the digital signal partially is stuck at an upper limit value of the reception side DSP 40 or the sampling phase detection unit 53. In digital signal processing, it is desirable that the number of clips is as close to 0 (zero) as possible. Therefore, in a case where both the detection sensitivity and the number of clips are considered, it is desirable to select a magnification of equal to or smaller than 1.5 times as the level adjustment value.

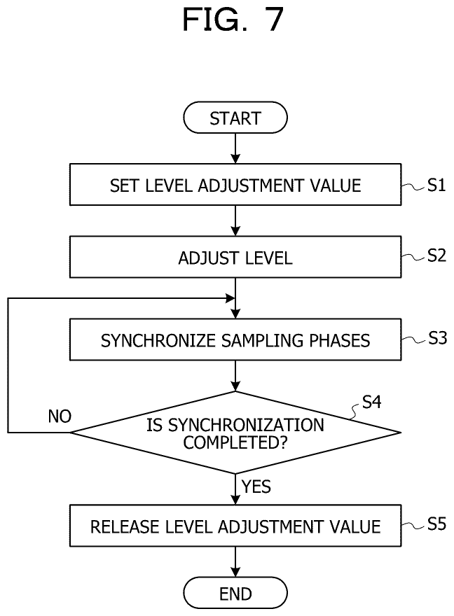

An example of an operation of the optical reception device 10R according to the first embodiment will be described with reference to FIG. 7. Note that an optical reception method of the present case is implemented by the control unit 60 executing a program corresponding to a flowchart illustrated in FIG. 7.

First, the control unit 60 sets the level adjustment value (step S1). For example, when an instruction from an external terminal device coupled to the optical reception device 10R is detected, the control unit 60 sets the level adjustment value. When the control unit 60 sets the level adjustment value, the level adjustment unit 52 adjusts the signal power of each of the X-channel and Y-channel digital signals (step S2).

When the level adjustment unit 52 adjusts the signal power, the sampling phase detection unit 53 synchronizes the sampling phases (step S3). For example, the sampling phase detection unit 53 detects the sampling phase errors, and executes initial phase drawing processing for converging the sampling phase errors in cooperation with the sampling phase compensation unit 51. As a result, input positions of the digital signals input in parallel are shifted and adjusted, and the sampled digital signals are adjusted to phase positions where the sampled digital signals should originally be. The sampling phase detection unit 53 continues the synchronization of the sampling phases until the synchronization of the sampling phases is completed (step S4: NO).

When the synchronization of the sampling phases is completed (step S4: YES), the control unit 60 releases the level adjustment value (step S5), and the optical reception device 10R ends the processing at the time of initial activation. For example, when the synchronization of the sampling phases is completed, the sampling phase detection unit 53 generates the sampling phase information including the compensation amounts corresponding to the sampling phase errors, and notifies the sampling phase compensation unit 51 of the sampling phase information. When the notification of the sampling phase information is performed, the sampling phase detection unit 53 instructs the control unit 60 to release the level adjustment value. As a result, the control unit 60 releases the level adjustment value. For example, in a case where the control unit 60 has set 1.5 times as the level adjustment value, the control unit 60 sets 1 time as the level adjustment value as the release of the level adjustment value.

In the optical reception device 10R according to the first embodiment, the level adjustment unit 52 is provided at a preceding stage of the sampling phase compensation unit 51. When the setting of 1.5 times is maintained as the level adjustment value and the operation of the optical reception device 10R is started, there is a possibility that the demodulation of the digital signals is affected. Therefore, in the first embodiment, when the synchronization of the sampling phases is completed, the control unit 60 sets 1 time as the level adjustment value. As a result, an influence caused by the level adjustment value on the demodulation of the digital signals is avoided.

### Second Embodiment

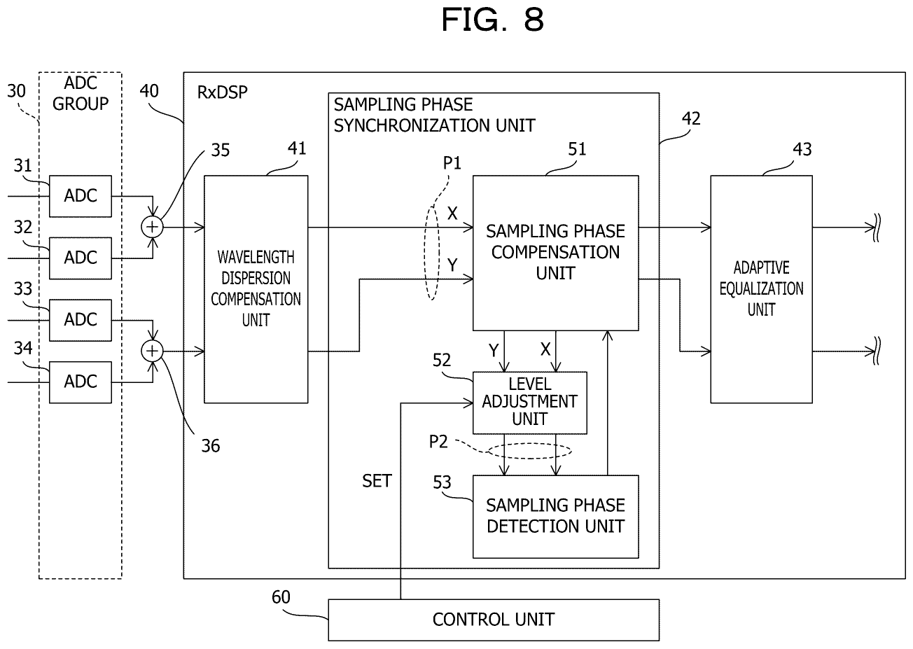

Next, a second embodiment of the present case will be described with reference to FIGS. 8 to 14. Note that a configuration similar to that of the optical reception device 10R described in the first embodiment is basically denoted by the same sign, and detailed description thereof will be omitted.

First, as illustrated in FIG. 8, a sampling phase synchronization unit 42 according to the second embodiment is different from the sampling phase synchronization unit 42 according to the first embodiment in arrangement of a level adjustment unit 52. The level adjustment unit 52 according to the second embodiment is provided in a non-demodulation path P2 arranged between a sampling phase compensation unit 51 and a sampling phase detection unit 53 independently of a demodulation path P1 that demodulates a digital signal.

In this manner, since the level adjustment unit 52 is provided in the non-demodulation path P2, an optical reception device 10R according to the second embodiment does not have to affect demodulation of the digital signal. Therefore, in the case of the second embodiment, the processing of step S5 described in the first embodiment is unnecessary, and a processing load of a control unit 60 is reduced. Note that, in this case, as in the first embodiment, any one of a plurality of modes is instructed to the control unit 60. As a result, the control unit 60 may uniquely set a level adjustment value corresponding to the mode in the level adjustment unit 52.

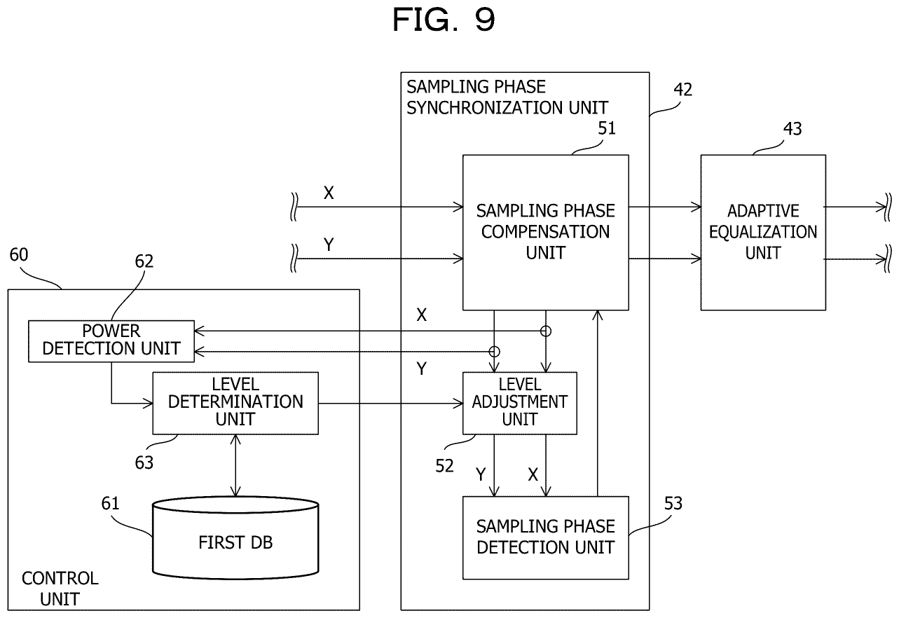

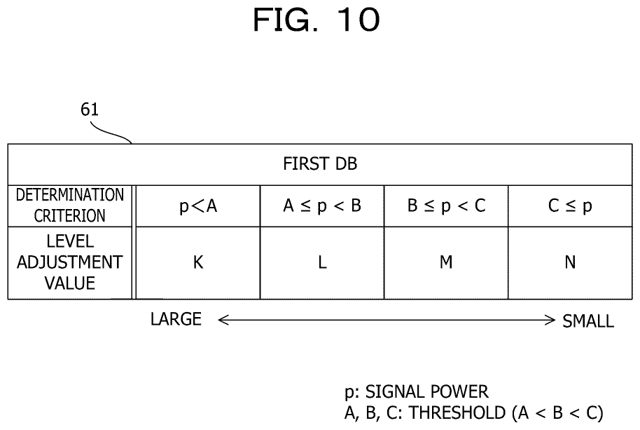

Next, a first modification of the optical reception device 10R according to the second embodiment will be described with reference to FIGS. 9 and 10.

As illustrated in FIG. 9, the control unit 60 according to the first modification includes a first database (DB) 61, a power detection unit 62, and a level determination unit 63. In the first DB 61, a relationship between a magnitude of signal power and a magnitude of a level adjustment value is defined. Smaller signal power is associated with a larger level adjustment value.

For example, as illustrated in FIG. 10, the first DB 61 stores a plurality of determination criteria and level adjustment values corresponding to the respective determination criteria. The determination criterion is a criterion for determining a relationship between signal power and three types of thresholds A, B, and C. The threshold A is the smallest numerical value among the thresholds A, B, and C. The threshold C is the largest numerical value among the thresholds A, B, and C. The threshold B is a numerical value between the threshold A and the threshold C. Instead of the three types of thresholds A, B, and C, two types of thresholds A and B may be adopted. Furthermore, instead of the three types of thresholds A, B, and C, four types of thresholds A, B, C, and D may be adopted.

Four types of level adjustment values K, L, M, and N are, for example, magnifications such as 1 time and 1.5 times. The level adjustment value K is the largest magnification among the level adjustment values K, L, M, and N. The level adjustment value N is the smallest magnification among the level adjustment values K, L, M, and N. Each of the level adjustment values L and M is the magnification between the level adjustment value K and the level adjustment value N. Note that the level adjustment value L is the magnification larger than the level adjustment value M. Instead of the four types of level adjustment values K, L, M, and N, three types of level adjustment values K, L, and M may be adopted. Furthermore, instead of the four types of level adjustment values K, L, M, and N, five types of level adjustment values J, K, L, M, and N may be adopted.

The power detection unit 62 acquires each of X-channel and Y-channel digital signals from the non-demodulation path P2. When each digital signal is acquired, the power detection unit 62 calculates signal power of each digital signal for each channel, and detects overall signal power of the digital signals obtained by adding each of the calculated signal power. When the signal power is detected, the power detection unit 62 outputs the signal power to the level determination unit 63.

When the signal power is input, the level determination unit 63 accesses the first DB 61, acquires a level adjustment value corresponding to the signal power, and determines the level adjustment value to be set in the level adjustment unit 52. When the level adjustment value is determined, the level determination unit 63 sets the determined level adjustment value in the level adjustment unit 52. As a result, unlike the first embodiment, the level adjustment value corresponding to the signal power detected based on each of the X-channel and Y-channel digital signals is dynamically set in the level adjustment unit 52. Therefore, it is unnecessary to prepare the external terminal device described in the first embodiment, and an operation burden on a person in charge of operating the terminal device may be reduced.

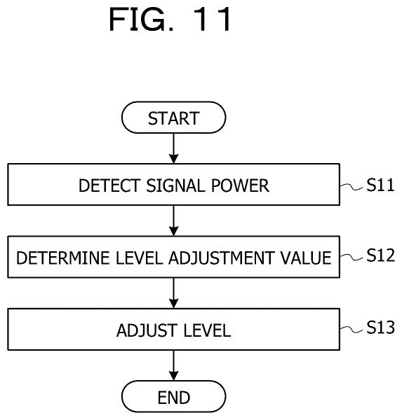

Next, an example of an operation in the first modification of the optical reception device 10R according to the second embodiment will be described with reference to FIG. 11.

First, the control unit 60 detects the signal power (step S11). For example, the power detection unit 62 of the control unit 60 acquires each of the X-channel and Y-channel digital signals, and detects the signal power based on the respective acquired digital signals. When the signal power is detected, the control unit 60 determines the level adjustment value (step S12). As described above, the level determination unit 63 of the control unit 60 determines the level adjustment value based on the signal power. When the level adjustment value is determined, the level determination unit 63 sets the determined level adjustment value in the level adjustment unit 52.

When the control unit 60 determines the level adjustment value, the level adjustment unit 52 adjusts a signal level of each of the X-channel and Y-channel digital signals (step S13). As a result, each of the X-channel and Y-channel digital signals whose signal level has been adjusted is input to the sampling phase detection unit 53. The sampling phase detection unit 53 generates the sampling phase information based on each input digital signal, and notifies the sampling phase compensation unit 51 of the sampling phase information. When the sampling phase detection unit 53 performs the notification of the sampling phase information, the optical reception device 10R ends the processing.

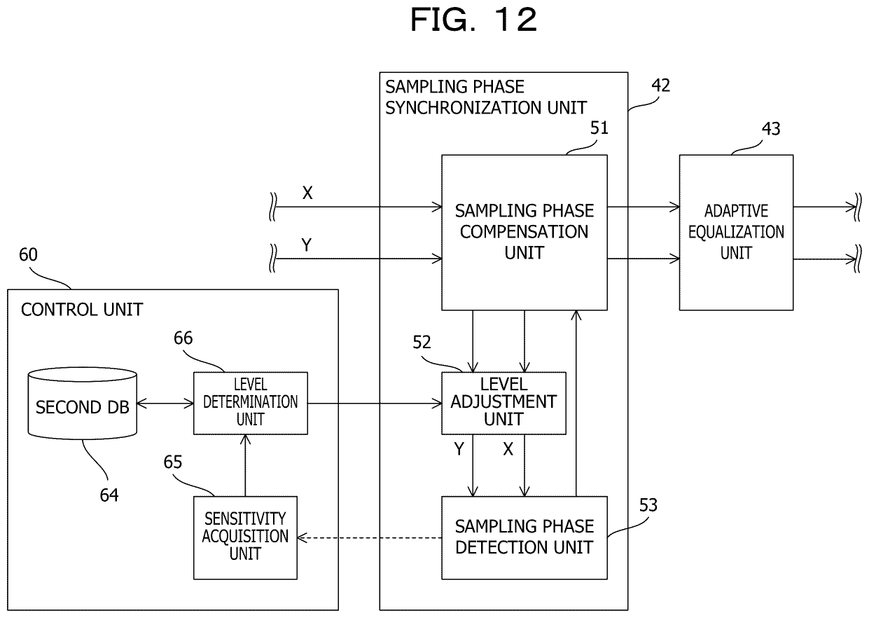

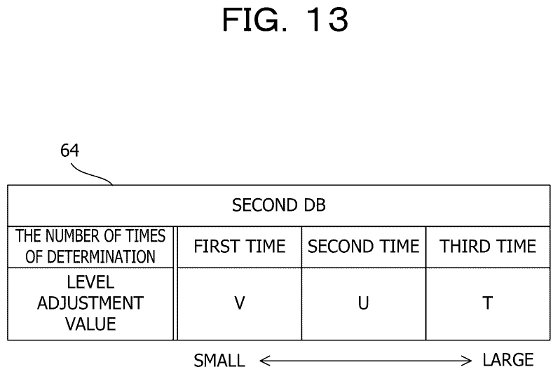

Next, a second modification of the optical reception device 10R according to the second embodiment will be described with reference to FIGS. 12 and 13.

As illustrated in FIG. 12, the control unit 60 according to the second modification includes a second DB 64, a sensitivity acquisition unit 65, and a level determination unit 66. In the second DB 64, a relationship between the number of times of determination of sensitivity and a magnitude of a level adjustment value is defined. As the number of times of determination of sensitivity increases, a larger level adjustment value is associated.

For example, as illustrated in FIG. 13, the second DB 64 stores a plurality of numbers of times of determination and level adjustment values corresponding to the respective numbers of times of determination. The number of times of determination is the number of times of determination as to whether or not phase detection sensitivity of a sampling phase is equal to or higher than threshold sensitivity. In a case where the phase detection sensitivity is less than the threshold sensitivity, the level adjustment value is changed (for example, increased), and it is determined again whether or not the phase detection sensitivity is equal to or higher than the threshold sensitivity. In FIG. 13, the number of times of determination up to a third time is indicated, but the number of times of determination may be up to a second time, or may be up to a fourth time or a fifth time.

Three types of level adjustment values V, U, and T are, for example, magnifications such as 1 time and 1.5 times. The level adjustment value V is the smallest magnification among the level adjustment values V, U, and T. The level adjustment value T is the largest magnification among the level adjustment values V, U, and T. The level adjustment value U is the magnification between the level adjustment value V and the level adjustment value T. Instead of the three types of level adjustment values V, U, and T, two types of level adjustment values V and U may be adopted. Furthermore, instead of the three types of level adjustment values V, U, and T, four types of level adjustment values V, U, T, and J may be adopted.

The sensitivity acquisition unit 65 acquires the phase detection sensitivity of the sampling phase from the sampling phase detection unit 53. When the phase detection sensitivity is acquired, the sensitivity acquisition unit 65 outputs the phase detection sensitivity to the level determination unit 66. When the phase detection sensitivity is input, the level determination unit 66 determines whether or not the phase detection sensitivity is equal to or higher than the threshold sensitivity, and counts the number of times of determination. In a case where the phase detection sensitivity is less than the threshold sensitivity, the level determination unit 66 changes the level adjustment value. For example, in a case where the level adjustment value V is set as an initial value in the level adjustment unit 52, the level adjustment value U is acquired from the second DB 64 and set in the level adjustment unit 52. As a result, the level determination unit 66 determines again whether or not the phase detection sensitivity is equal to or higher than the threshold sensitivity.

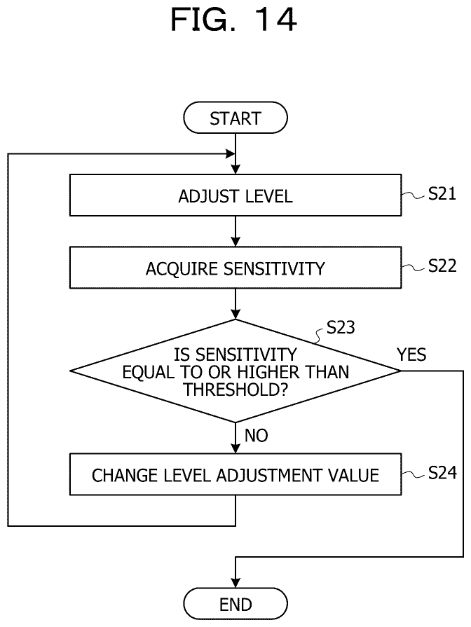

Next, an example of an operation in the second modification of the optical reception device 10R according to the second embodiment will be described with reference to FIG. 14.

First, the level adjustment unit 52 adjusts a signal level of each of X-channel and Y-channel digital signals (step S21). For example, in a case where the level adjustment value V is set in the level adjustment unit 52, the level adjustment unit 52 adjusts the signal level of each of the X-channel and Y-channel digital signals based on the level adjustment value V.

Next, the control unit 60 acquires the sensitivity (step S22). For example, the sensitivity acquisition unit 65 of the control unit 60 acquires the phase detection sensitivity of the sampling phase from the sampling phase detection unit 53, and outputs the acquired phase detection sensitivity to the level determination unit 66. Next, the level determination unit 66 determines whether or not the sensitivity is equal to or higher than the threshold (step S23). For example, the level determination unit 66 determines whether or not the phase detection sensitivity is equal to or higher than the threshold sensitivity.

In a case where the phase detection sensitivity is less than the threshold sensitivity (step S23: NO), the level determination unit 66 changes the level adjustment value (step S24). For example, the level determination unit 66 changes the level adjustment value V to the level adjustment value U. When the level determination unit 66 changes the level adjustment value, the level adjustment unit 52 executes the processing of step S21. The processing of steps S21 to S24 is repeated until the phase detection sensitivity becomes equal to or higher than the threshold sensitivity. Then, when the phase detection sensitivity becomes equal to or higher than the threshold sensitivity (step S23: YES), the level determination unit 66 ends the processing.

In this manner, the change of the level adjustment value is stopped when the phase detection sensitivity becomes equal to or higher than the threshold sensitivity. As a result, the level determination unit 66 may stop the continuous increase in the level adjustment value. Therefore, the optical reception device 10R may avoid a significant increase in the number of clips (see FIG. 6).

While the preferred embodiments have been described in detail thus far, the embodiments are not limited to specific embodiments, and various modifications and alterations may be made within the scope of the present embodiments described in the claims.

For example, in the embodiments described above, the PCS-16QAM has been described as an example of the multi-level modulation system to which the PCS is applied, but the multi-level modulation system to which the PCS is applied is not limited to this. For example, PCS-64QAM or the like may be used as the multi-level modulation system to which the PCS is applied.

Furthermore, in the embodiments described above, the Gardner system is adopted as an example of the phase detection method, but a diversity addition type phase detection method may be adopted instead of the Gardner system or together with the Gardner system. Moreover, not limited to the setting of the level adjustment value by the control unit 60, the level adjustment value may be set in the level adjustment unit 52 in advance.

All examples and conditional language provided herein are intended for the pedagogical purposes of aiding the reader in understanding the invention and the concepts contributed by the inventor to further the art, and are not to be construed as limitations to such specifically recited examples and conditions, nor does the organization of such examples in the specification relate to a showing of the superiority and inferiority of the invention. Although one or more embodiments of the present invention have been described in detail, it should be understood that the various changes, substitutions, and alterations could be made hereto without departing from the spirit and scope of the invention.

What is claimed is:

1. An optical reception device comprising:
a reception circuit that performs digital coherent reception of an optical signal to which a probabilistic constellation shaping (PCS) is applied;
a conversion circuit that samples an electric field signal in an analog format that represents an optical electric field component of the optical signal and converts the electric field signal into a digital signal in a digital format;
a detection circuit that detects a sampling phase of the digital signal and generates sampling phase information that corresponds to the sampling phase;
a compensation circuit that compensates for the sampling phase of the digital signal based on the sampling phase information; and
an adjustment circuit that adjusts signal intensity of the digital signal before the sampling phase information is generated.

2. The optical reception device according to claim 1, further comprising:
a control circuit that sets an adjustment value that increases the signal intensity in the adjustment circuit and releases the adjustment value after the sampling phase information is notified from the detection circuit to the compensation circuit,
wherein the adjustment circuit is provided in a preceding stage of the compensation circuit and adjusts the signal intensity based on the adjustment value.

3. The optical reception device according to claim 1, further comprising:
a control circuit that sets an adjustment value that increases the signal intensity in the adjustment circuit,
wherein the adjustment circuit is provided in a non-demodulation path arranged between the compensation circuit and the detection circuit independently of a demodulation path that demodulates the digital signal, and adjusts the signal intensity based on the adjustment value.

4. The optical reception device according to claim 3, wherein the control circuit acquires the digital signal from the non-demodulation path, detects the signal intensity of the acquired digital signal, and sets the adjustment value that corresponds to the detected signal intensity in the adjustment circuit.

5. The optical reception device according to claim 3, wherein the control circuit acquires phase detection sensitivity of the sampling phase from the detection circuit, and sets the adjustment value that corresponds to the acquired phase detection sensitivity in the adjustment circuit.

6. The optical reception device according to claim 1, wherein the detection circuit detects the sampling phase based on a phase detection method that includes a Gardner system.

7. An optical reception method comprising:
performing digital coherent reception of an optical signal to which a probabilistic constellation shaping (PCS) is applied;
sampling an electric field signal in an analog format that represents an optical electric field component of the optical signal;
converting the electric field signal into a digital signal in a digital format;
detecting a sampling phase of the digital signal;
generating sampling phase information that corresponds to the sampling phase;
compensating for the sampling phase of the digital signal based on the sampling phase information; and
adjusting signal intensity of the digital signal before the sampling phase information is generated.

8. The optical reception method according to claim 7, wherein, in the processing of detecting the sampling phase, the sampling phase is detected based on a phase detection method that includes a Gardner system.
